(19) United States
(12) Patent Application Publication
(10) Pub. No.: US 2025/0196642 A1
(43) Pub. Date: Jun. 19, 2025

(54) METHOD OF DISPLAYING INFORMATION THROUGH A WINDSHIELD OF A VEHICLE AND A VEHICLE ACCORDING TO THE SAME

(71) Applicants: HYUNDAI MOTOR COMPANY, Seoul (KR); Kia Corporation, Seoul (KR)

(72) Inventors: Ryung Hwa Rhee, Hwaseong-si (KR); Eun Aee Ko, Hwaseong-si (KR); Jin Young Park, Hwaseong-si (KR); Ik Jae Kwon, Hwaseong-si (KR); Seong Hun Nam, Hwaseong-si (KR)

(73) Assignees: HYUNDAI MOTOR COMPANY, Seoul (KR); Kia Corporation, Seoul (KR)

(21) Appl. No.: 18/967,197

(22) Filed: Dec. 3, 2024

(30) Foreign Application Priority Data
Dec. 18, 2023 (KR) 10-2023-0184547

(51) Int. Cl. B60K 35/28; B60K 35/233; B60K 35/81

(52) U.S. Cl. CPC B60K 35/28; B60K 35/233; B60K 35/81; B60K 2360/164; B60K 2360/166; B60K 2360/167; B60K 2360/177; B60K 2360/21; B60K 2360/785

(57) ABSTRACT

A vehicle includes a windshield configured to transmit a front view of the vehicle to an interior of the vehicle, and a display device configured to display information set to overlap the front view on the windshield, and to divide the windshield into a first display area including a driving lane, both sides of the driving lane, and an upper settings area, and at least one peripheral display area located in a periphery of the first display area, display at least one of driving energy information, speed information, driving lane information, augmented reality (AR) turn by turn (TBT) information, traffic signal information, a distance to a vehicle ahead, warnings, and surrounding vehicles information on the first display area, and display at least one of destination arrival information, media content information, surrounding real image, audio video navigation (AVN) menu, speed limit information, and local geographic information on the peripheral display area.

### CROSS-REFERENCE TO RELATED APPLICATION

The present application claims priority to Korean Patent Application No. 10-2023-0184547, filed on Dec. 18, 2023, the entire contents of which is incorporated herein for all purposes by this reference.

### BACKGROUND OF THE PRESENT DISCLOSURE

### Field of the Present Disclosure

The present disclosure relates to a method of displaying driving-related information or media content information through a windshield of a vehicle and the vehicle using the method.

### Description of Related Art

Devices that display driving-related information through a windshield of a vehicle have been developed and are being used.

Examples of the display devices using a windshield include a head-up display device.

A conventional windshield display device displays information only in a very limited and small area, not using an entire area. Therefore, the conventional windshield display device not only lacks convenience but also has limitations on the type or the amount of information to display.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method for displaying information by use of almost the entire area of a windshield of a vehicle or the vehicle using the method.

Furthermore, an exemplary embodiment of the present disclosure is provided to improve user convenience by increasing the number of types or the volume of information provided through the windshield of the vehicle.

An exemplary embodiment of the present disclosure is provided to various information by displaying driving or user convenience information using an entire area of a windshield.

Furthermore, according to an exemplary embodiment of the present disclosure, a windshield area is divided into areas depending on with whether visibility for the outside environment is ensured or not, and information is effectively displayed according to each area.

According to an exemplary embodiment of the present disclosure, there is provided a vehicle including a windshield configured to allow for a front view of the vehicle to be seen from an interior of the vehicle; and a display device configured to display preset information on the windshield overlapping the front view.

The display device may be further configured to divide the windshield into a first display area and at least one peripheral display area located in a periphery of the first display area, wherein the first display area is set to include a driving lane of the vehicle, both sides and an upper area of the driving lane with respect to a view seen from the interior of the vehicle toward a straight forward driving direction of the vehicle, display at least one of driving energy information, speed information, driving lane information, augmented reality (AR) turn by turn (TBT) information, traffic signal information, a distance to a vehicle ahead, warnings, and information related to surrounding vehicles on the first display area, and display at least one of destination arrival information, media content information, a surrounding real image, an audio video navigation (AVN) menu, speed limit information, and local geographic information on the peripheral display area.

In at least an exemplary embodiment of the present disclosure, the windshield is divided into a driver seat area and a passenger seat area, the driver seat area includes an internal upper area, an external upper area, an external lower area, and an internal lower area as four quadrant areas with reference to a center portion of the driver seat area, and the first display area includes at least one portion of the internal upper area, at least one portion of the external upper area, at least one portion of the external lower area, and an entire area of the internal lower area.

The peripheral display area may include at least one of a second display area located in the external lower area of the driving seat area, a third display area located across the external upper area and the internal upper area of the driver seat area, and a fourth display area located in the passenger seat area.

The display device may be further configured to display at least one of a plurality of pieces of navigation TBT information, the speed limit information, and local geographic information on the second display area, display at least one of the Audio, Video and Navigation (AVN) menu, the media content information, the destination arrival information, and the surrounding real image on the third display area, and display at least one of music lyrics and a media content list on the fourth display area.

The media content information may include playback information of a media content, and wherein the display device displays an AR driving lane line overlapping a line of the driving lane of the first display area in a waveform corresponding to music streaming of the media content according to playback of the media content.

The display device may be further configured to, in response to the media content information displayed on the third display area being dragged to the first display area by a user input, display the AR driving lane in a waveform corresponding to the music streaming.

The display device may be further configured to, in response to the media content information displayed on the third display area or the AR driving lane displayed in the waveform corresponding to the music streaming being dragged to the fourth display area by a user input, display detailed information of the media content on the fourth display area.

The display device may be further configured to, in response to one of a settings menu of the AVN menu displayed on the third display area being selected and dragged to the fourth display area, display a detailed settings menu of the settings menu on the fourth display area.

The surrounding real image may include a rear-view camera image, and the display device may be further configured to, in response to a user input or a change of a driving direction of the vehicle to reverse, expand the rear-view camera image to the first display area, or display a side-view camera image with the expanded rear-view camera image.

The display device may be further configured to, display a plurality of map theme menus on the third display area, and in response to selecting at least one of the plurality of map theme menus, display an AR content corresponding to the at least one of the selected plurality of map theme menus on the first display area.

According to an exemplary embodiment of the present disclosure, there is provided a method of displaying information by a display device on a windshield of a vehicle, the windshield configured to allow for a front view of the vehicle to be seen from an interior of the vehicle, and the display device configured to display preset information on the windshield overlapping the front view, the method including dividing the windshield into a first display area and at least one peripheral display area located in a periphery of the first display area, wherein the first display area is set to include a driving lane of the vehicle, both sides and an upper area of the driving lane with respect to a view seen from the interior of the vehicle toward a straight forward driving direction of the vehicle, displaying at least one of driving energy information, speed information, driving lane information, augmented reality (AR) turn by turn (TBT) information, traffic signal information, a distance to a vehicle ahead, warnings, and information related to surrounding vehicles on the first display area, and displaying at least one of destination arrival information, media content information, a surrounding real image, an audio video navigation (AVN) menu, speed limit information, and local geographic information on the peripheral display area.

In a method of at least an exemplary embodiment of the present disclosure, the windshield is divided into a driver seat area and a passenger seat area, the driver seat area includes an internal upper area, an external upper area, an external lower area, and an internal lower area as four quadrant areas with reference to a center portion of the driver seat area, and the first display area includes at least one portion of the internal upper area, at least one portion of the external upper area, at least one portion of the external lower area, and an entire area of the internal lower area.

The peripheral display area may include at least one of a second display area in the external lower area of the driver seat area, a third display area located across the external upper area and the internal upper area of the driver seat area, and a fourth display area located in the passenger seat area.

The method may further include displaying at least one of a plurality of pieces of navigation TBT information, the speed limit information, and the local geographic information on the second display area, displaying at least one of the AVN menu, the media content information, the destination arrival information, and the surrounding real image on the third display area, and displaying at least one of music lyrics, and a media content list on the fourth display area.

The media content information may include playback information of a media content, and wherein the method further includes displaying an AR driving lane line overlapping a line of the driving lane displayed on the first display area in a waveform corresponding to music streaming of the media content according to play back of the media content.

The method may further include, in response to the media content information displayed on the third display area being dragged to the first display area by a user input, displaying the AR driving lane in a waveform corresponding to the music streaming.

The method may further include, in response to the media content information displayed on the third display area or the AR driving lane displayed in the waveform corresponding to the music streaming being dragged to the fourth display area by a user input, displaying detailed information of the media content on the fourth display area.

The method may further include, in response to a settings menu of the AVN menu displayed on the third display area being selected and dragged to the fourth display area, displaying a detailed settings menu of the settings menu on the fourth display area.

The surrounding real image may include a rear-view camera image, and the method may further include, in response to a user input or a change of a driving direction of the vehicle to reverse, expanding the rear-view camera image to the first display area, or displaying a side-view camera image with the expanded rear-view camera image.

The method may further include, displaying a plurality of map theme menus on the third display area, and in response to selecting at least one of the plurality of map theme menus, displaying an AR content corresponding to the at least one of the selected plurality of map theme menus on the first display area.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating blocking areas of a windshield according to an exemplary embodiment of the present disclosure;

FIG. 2 is an exemplary view exemplarily illustrating that information is displayed according to the blocking areas of the windshield according to an exemplary embodiment of the present disclosure;

FIG. 3A, FIG. 3B, and FIG. 3C, FIG. 4A, FIG. 4B, and FIG. 4C, FIG. 3B, and FIG. 3C, and FIG. 5A and FIG. 5B are exemplary views exemplarily illustrating that a driver operates the information displayed on the windshield according to an exemplary embodiment of the display;

FIG. 6A, FIG. 6B and FIG. 6C are views exemplarily illustrating that a surrounding real image displayed on a third display area is expanded to a first display area according to an exemplary embodiment of the present disclosure; and

FIG. 7A and FIG. 7B and FIG. 8A and FIG. 8B are views exemplarily illustrating that augmented reality (AR) content displayed on the first display area changes according to a selection of a map theme menu displayed on the third display area according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

While embodiments are described with reference to the accompanying drawings, it should be understood that various changes and modifications may be made in an exemplary embodiment of the present disclosure. Furthermore, it should be understood that the present disclosure is not limited to the specific embodiments thereof, and various changes, equivalences, and substitutions may be made without departing from the scope and spirit of the present disclosure.

In the exemplary embodiments of the present disclosure, terms such as “module”, “unit”, “part”, and the like are terms used for nominal distinct between components, and it should not be interpreted as assuming that they are physically and chemically separated or capable of being separated or divided.

Terms containing ordinal numbers, such as “first”, “second”, etc., may be used to describe various components, but the components are not limited by the terms. These terms may be used only in a nominal sense to differentiate one component from another component, and their mutual sequential meaning will be understood through the context of the corresponding description, not through such terms.

The term “and/or” is used to include all instances of any combination of multiple items being the subject. For example, “A and/or B” includes all three cases: “A”, “B”, and “A and B”.

When a component is used to be “coupled” or “connected” to another component, it will be understood that the component may be either directly connected to another component, or connected indirectly via another medium.

The terms in the present application are used to describe an exemplary embodiment and do not intend to restrict and/or limit the present disclosure. Singular forms are intended to include plural forms unless the context clearly indicates otherwise. According to an exemplary embodiment of the present disclosure, terms such as “comprise” or “consist of” are used to designate presence of characteristics, numbers, steps, operations, elements, components or a combination thereof, and do not foreclose the presence or possibility of addition of one or more other characteristics, numbers, steps, operations, elements, components or a combination thereof.

Unless otherwise defined, all terms used in the exemplary embodiment of the present disclosure including technical or scientific terms, include the same meaning as generally understood by an ordinary person skilled in the field of the present disclosure to which the present disclosure pertains. Terms defined in commonly used dictionaries will be interpreted as having a meaning consistent with the meaning in the context of the related technology, and unless clearly defined in the present application, should not be interpreted in an ideal or excessively formal sense.

Furthermore, the terms “unit”, “control unit”, “control device”, or “controller” are only widely used for names of devices that control the corresponding functions, and are not construed as being generic functional units. For example, devices using the terms may include a communication device that communicates with another controller or sensor to control the corresponding function, a computer-readable recording media that stores operating systems, logic commands, input/output information, etc., and at least one or more of processor that is configured to perform determination, calculation, decision, etc. used to control the corresponding function.

A processor may include a semiconductor integrated circuit and/or electronic elements that perform at least one or more of comparison, determination, calculation, and decision to achieve a programmed function. For example, the processor may be one or the combination of a computer, a microprocessor, a CPU, an ASIC, and electronic circuits (circuitry, logic circuits).

A computer-readable recording medium (or referred to as memory) includes all types of non-transitory storage devices that store data which is read by a computer system. Examples of the computer-readable recording medium may include at least one a memory of flash memory type, hard disk type, micro type, and card type (e.g., Secure Digital Card (SD Card) or eXtream Digital Card (XD Card)), and a memory of Random Access Memory (RAM), Static RAM (SRAM), Read-Only Memory (ROM), Programmable ROM (PROM), Electrically Erasable PROM (EEPROM), and magnetic RAM (MRAM), a magnetic disk, and an optical disk type.

Such recording medium may be electrically connected to the processor, and the processor may load and record data from the recording medium. The recording medium and processor may be integrated or may be physically separated.

An exemplary embodiment of the present disclosure will be explained with reference to the drawings.

A display device 2 according to various exemplary embodiments of the present disclosure may be a head-up display device, but is not limited thereto when a windshield 1 is used as a display area.

An optical see-through type head-up display device may be a method in which a user sees the outside of a vehicle with naked eyes through a transparent display, and simultaneously sees a virtual object on the transparent display overlapping. Examples of the optical see-through method may include a display panel method, a laser method, and a projection method.

The display panel method may be a method of mounting a transparent display such as a liquid crystal display (LCD) or an organic light-emitting diode (OLED) on a glass front window of a vehicle or between a driver and the glass front window of the vehicle, and presenting a virtual object on the transparent display so that the driver sees the virtual object and a scene of real world on the transparent display simultaneously.

The laser method may be a method of applying a material that emits upon receiving laser light on the front glass window of the vehicle and then, obtaining a laser beam to provide information.

The projection method may be a method of mounting a projection optical device in a vehicle and projecting an image toward a glass front window (i.e., windshield) of a vehicle whereby portion of the projected image is reflected on a windshield for a user to see.

A video see-through method may be a method of overlapping a real-world image captured by a camera with a virtual object in a graphic image to provide the overlapped image to a user through a monitor.

The display device 2 according to an exemplary embodiment of the present disclosure may use the entire area of the windshield 1 as a display area.

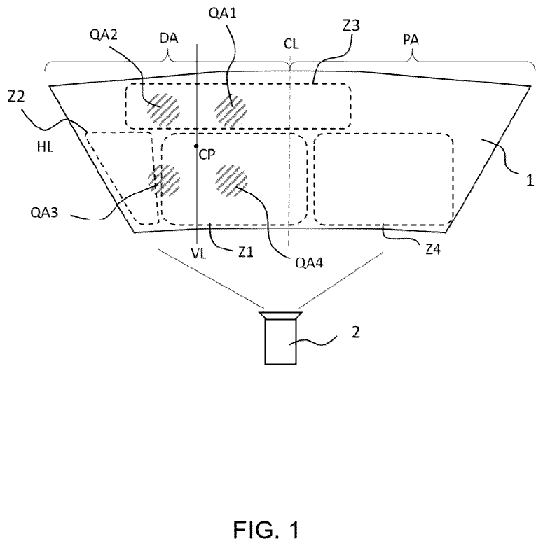

As shown in FIG. 1, the display device 2 according to various exemplary embodiments of the present disclosure may include a plurality of areas in the entire area of the windshield 1.

In an exemplary embodiment of the present disclosure, the display device 2 may be implemented with a controller or connected to a controller and the controller may include at least a processor.

Referring to FIG. 1, the windshield 1 may be horizontally divided in half with reference to a virtual central vertical line CL, including a driver seat area DA and a passenger seat area PA.

The driver seat area of a right-hand drive vehicle may be located to the right of the central vertical line CL, and the driver seat area of a left-hand drive vehicle may be located to the left of the central vertical line CL.

According to an exemplary embodiment of the present disclosure, the description is made based on the left-hand drive vehicle but is not limited thereto.

Referring to FIG. 1, the driver seat area DA may be divided into four areas with reference to a center point CP, including an internal upper area QA1, an external upper area QA2, an external lower area QA3, and an internal lower area QA4.

Referring to FIG. 1, with reference to the center point CP of the driver seat area DA, Quadrant 1 may be the internal upper area QA1, Quadrant 2 may be the external upper area QA2, and Quadrant 3 may be the external lower area QA3, and Quadrant 4 may be the internal lower area QA4.

In the case of a right-hand drive vehicle, the passenger seat area PA of FIG. 1 may be the driver seat area DA. When the driver seat area DA is divided into four areas, Quadrant 1 may be the external upper area QA2, Quadrant 2 may be the internal upper area QA1, Quadrant 3 may be the internal lower area QA4, and Quadrant 4 may be the external lower area QA3.

According to an exemplary embodiment of the present disclosure, the driver seat area DA of the display device 2 may include a first display area Z1 including at least portion of the internal upper area QA1, at least portion of the external upper area QA2, at least portion of the external lower area QA3, and the entire area of the internal lower area QA4.

The first display area Z1 may include, when viewed from the interior of the vehicle toward a straightforward driving direction, the driving lane of the vehicle, both sides of the driving lane, and an upper settings area.

As peripheral display areas, a second display area Z2, a third display area Z3, and a fourth display area Z4 may be located in the periphery of the first display area Z1.

Referring to FIG. 1, in the driver seat area DA, the second display area Z2 may be located in the external lower area QA3, the third display area Z3 may be located across the external upper area QA2, and the internal upper area QA1, and the fourth display area Z4 may be located in the passenger seat area PA.

The display device 2 according to an example may include different types or contents of information output for each display area.

The first display area Z1 may ensure visibility of the actual situation projected in the front of the vehicle for driving safety and while driving, the viewing angle of the driver may be focused in the first display area Z1.

The first display area Z1 may ensure the highest visibility and readability for a driver among the areas of the windshield 1 area.

The information output on the first display area Z1 may be directly related to driving safety or top priority information provided to a driver.

For example, the information output on the first display area Z1 may include real-time driving information.

The information output on the first display area Z1 may include driving information to be mapped with driving environment. For example, the information output on the first display area Z1 may include at least one of AR TBT (Turn By Turn) information, lane information, traffic signal information, a distance to a vehicle ahead, driving status information, various warnings about safety-related emergency situations such as a conflict with other objects (e.g. a leading vehicle, a pedestrian, or the like), a line departure, or speeding, etc.

The information output on the first display area Z1 may be information considering the outside environment and including driving lane marks in severe weather conditions or surrounding vehicles information, etc.

The second display area Z2 may be within the viewing angle of the driver while driving and may require the second highest visibility and readability following the first display area Z1.

The information output on the second display area Z2 may include driving assistance information. For example, the information output on the second display area Z2 may include navigation TBT information, speed limit information, or local geographic information such as a school zone or a green zone.

The third display area Z3 may be relatively easy for the driver to access while looking straight ahead. On the third display area Z3, the displayed information may be easily operated through a gesture recognition device while driving.

The information output on the third display area Z3 may include, for example, an Audio Video Navigation (AVN) menu which is used while driving, media content information which is constantly displayed (e.g., a playing bar indicating media content playback status), destination arrival information or a real image of the surrounding area.

The surrounding real image may include, as a digital Rear View Mirror (RVM) function, a rear-view real image by a rear-view camera, and a rear side-view real image by a camera mounted in a side mirror.

The fourth display area Z4 may be accessible only when the driver looks sideways or consciously turns his or her head.

The information output on the fourth display area Z4 may include additional information which is not related to driving. For example, the information output on the fourth display area Z4 may include the list of media contents or music lyrics displayed on a window while driving.

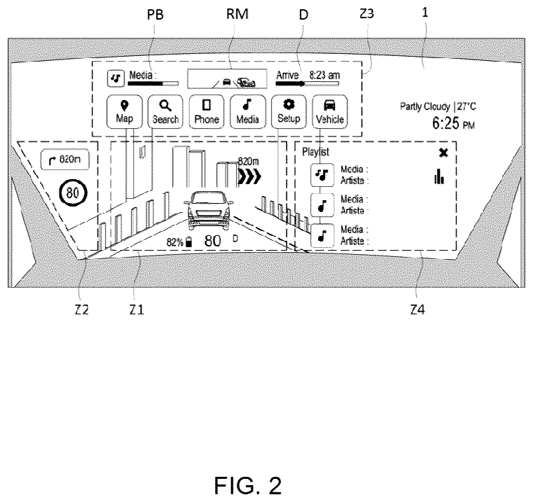

FIG. 2 illustrates information displayed on the windshield 1, and the description thereof will be made below.

Referring to FIG. 2, the driving lane, right and left adjacent lanes of the driving lane, and buildings in the distance may be seen through the first display area Z1 as a real scene of a front view of a vehicle.

The information displayed on the first display area Z1 may include fuel or battery remaining information and vehicle speed information ‘80 km/h’ at the bottom portion. An AR image may be mapped and displayed for both lanes of the vehicle, and AR TBT information indicating to turn right ahead ‘820 m’ may be displayed. The AR lane image may be the positions of both sides of the driving lane and displayed in the predetermined position.

The navigation TBT information may be displayed at the top portion of the second display area Z2, and the speed limit information may be displayed below the navigation TBT information.

The third display area Z3 may display a playing bar PB indicating the playback status of media content as media content information at the top, digital RVM, i.e., a real image RM by a rear-view camera at the center portion of the top, and destination arrival information D on the right.

The third display area Z3 may display AVN menus including ‘Map’ for displaying maps, ‘Search’ for searching destinations, ‘Phone’ for making or receiving calls, ‘Media’ for selecting and playing media content, ‘Setup’ for setting up an AVN function, and ‘Vehicle’ for a vehicle settings menu at the bottom portion.

The fourth display area Z4 may display the list of the media contents, and weather and time information on the top.

The information output from the display device 2 may be operated by an operating portion such as a jog stick provided next to the driver seat or a gesture recognition device.

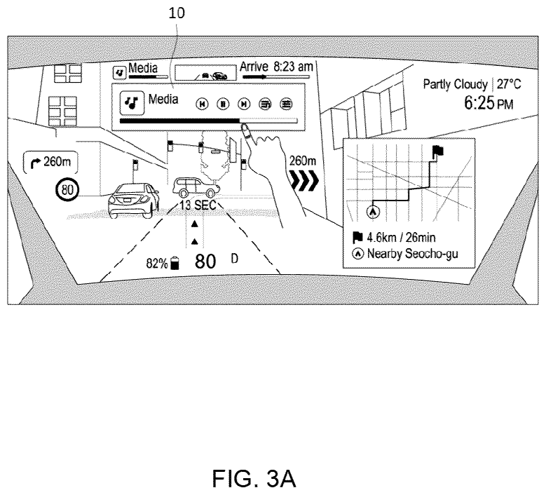

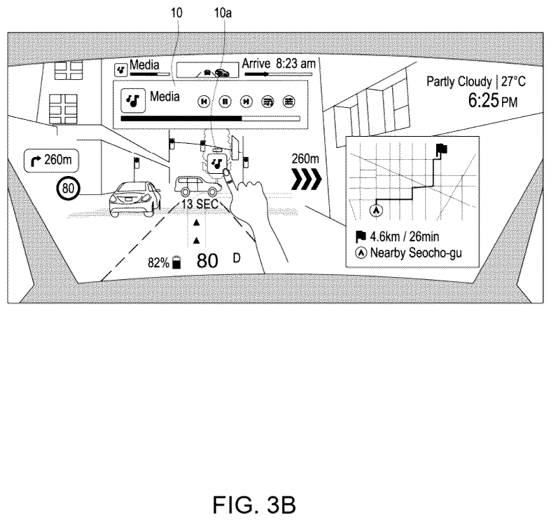

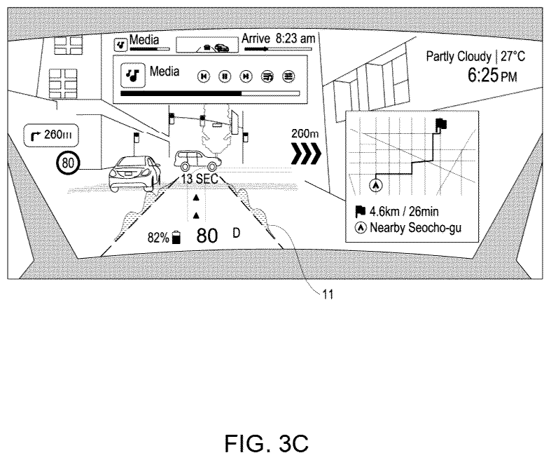

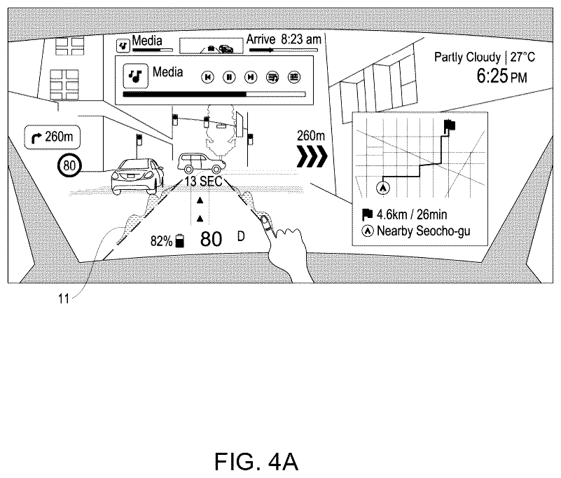

FIGS. 3A-3C illustrate the operation of the information displayed on the windshield 1 by a gesture recognition device.

Referring to FIG. 3A, a driver may manually drag a playing bar as media content information 10 displayed on the third display area Z3 and move the information to the first display area Z1 as shown in FIG. 3B.

Referring to FIG. 3B, as an icon image indicating the media content being dragged, a singer image 10a of the content may be moved along with a hand movement to display.

As the image is dragged to the first display area Z1, as shown in FIG. 3C, an AR vehicle lane 11 mapped to the driving lane of the vehicle on the first display area Z1 may be displayed in a waveform corresponding to the output of the music streaming.

Referring to FIGS. 4A-4C, as shown in FIG. 4A, when the driver selects the AR driving lane 11 in the waveform according to the music streaming and drags the AR driving lane 11 to the fourth display area Z4 as shown in FIG. 4B and FIG. 4C, the lyrics of the content may be displayed on the fourth display area Z4 as detailed information 12 of the content.

Furthermore, it may be possible to select a media content from the third display area Z3 and drag the content to the fourth display area Z4, so that the lyric of the content may be displayed on the fourth display area Z4 accordingly.

FIG. 5A illustrates sub-menus of the ‘Vehicle’ menu displayed on the third display area Z3. When a ‘Sounding Setting’ menu 20 is selected, as shown in FIG. 5B, a sub-menu 21 for setting the output of speakers mounted in the vehicle may be displayed on the fourth display area Z4.

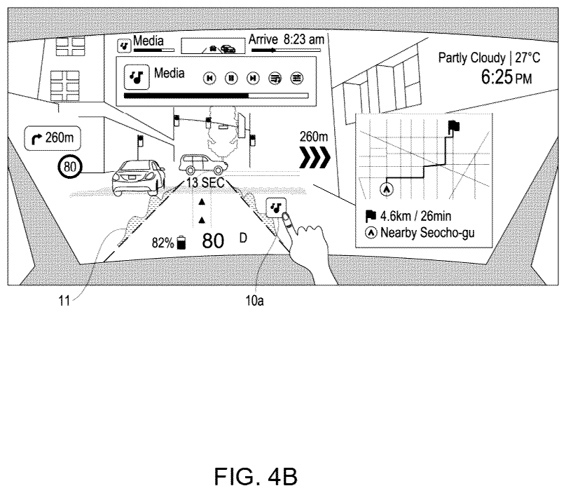

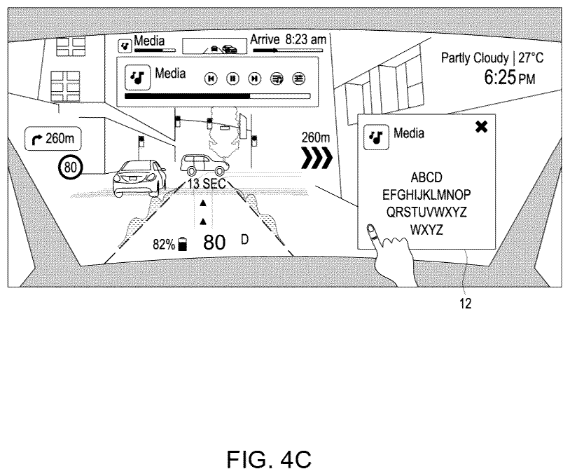

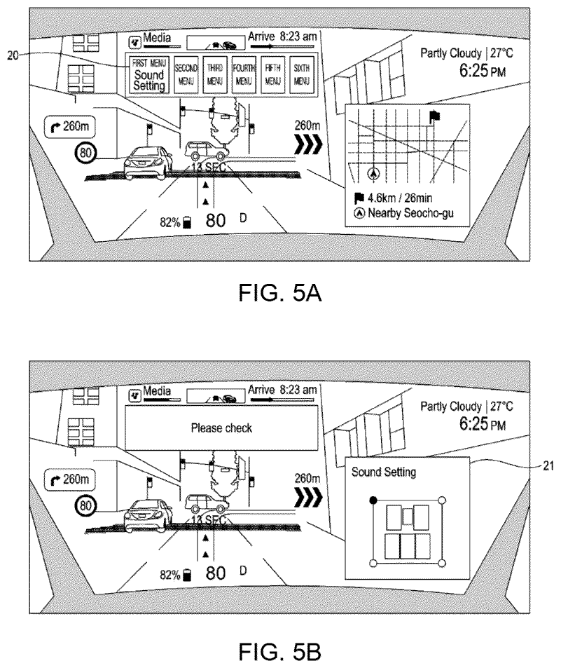

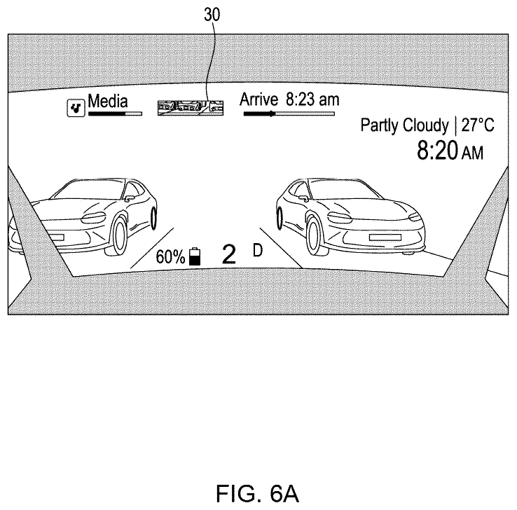

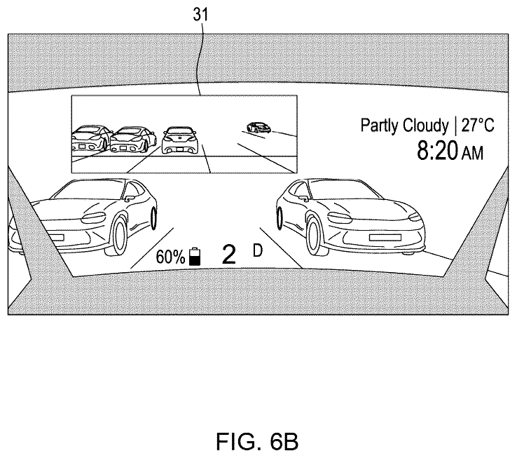

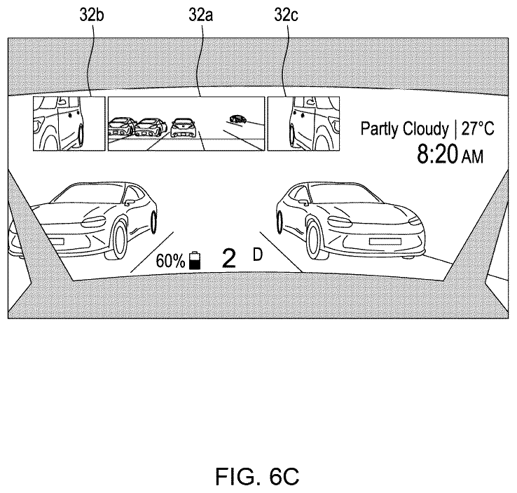

As a user input through an operating portion, or the driving direction of the vehicle is switched to reverse, (e.g., as a gear-shift lever is switched to ‘R’), as shown in FIG. 6A, a small real image 30 of the rear-view camera displayed on the third display area Z3 may be expanded to the first display area Z1 as shown in FIG. 6B and output as an expanded image 31.

Referring to FIG. 6C, as a rear-view camera image 32a is expanded, a left rear-view real image 32b by a left-side mirror camera may be output on the left side, and a right rear-view real image 32c by a right-side mirror camera may be output on the right side.

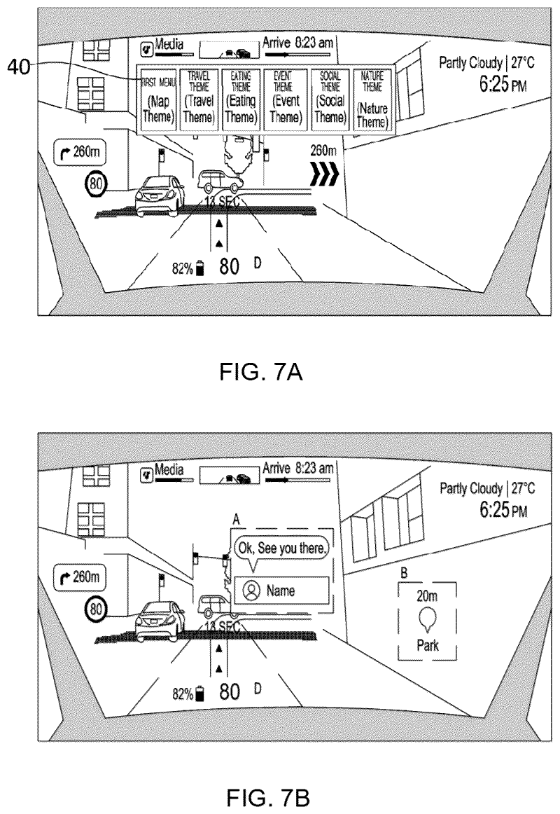

FIG. 7A illustrates that a map theme menu 40 on the third display area Z3 may include ‘Travel Theme’, ‘Eating Theme’, ‘Event Theme’, ‘Social Theme’, ‘Nature Theme’, etc.

Referring to FIG. 7A, as the ‘Social Theme’ is selected among the map theme menu 40, as shown in FIG. 7B, information such as relative distances and directions to other users may be displayed.

A user may make a phone call to other users while driving, and the content of the phone call may be displayed through a voice recognition device mounted in the vehicle as shown in FIG. 7B.

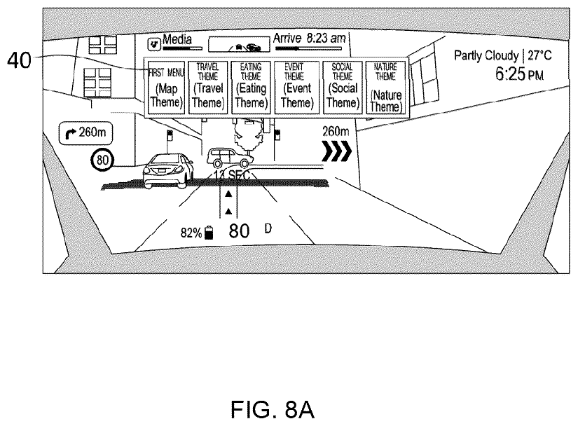

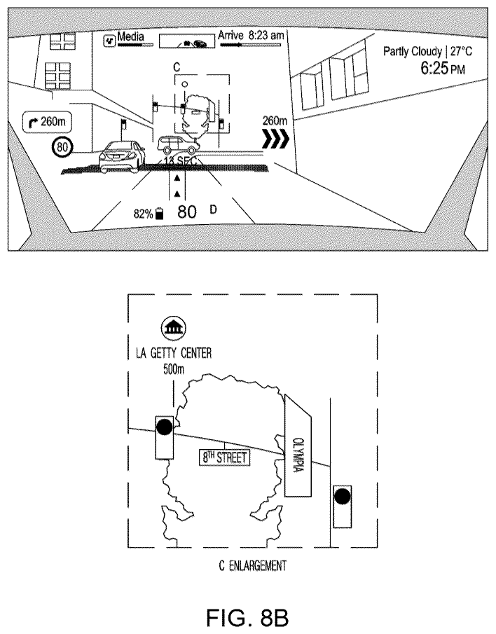

Referring to FIG. 8A, as the ‘Travel Theme’ is selected among the map theme menu 40, as shown in FIG. 8B, information of landmarks within the range of areas designated from the current location of the vehicle may be displayed.

For instance, referring to FIG. 8B, as the ‘Travel Theme’ is selected, information may be displayed that LA getty center portion is located 500 m ahead.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle, comprising:
a windshield configured to allow for a front view of the vehicle to be seen from an interior of the vehicle; and
a display device configured to display preset information on the windshield overlapping the front view,
wherein the display device including a processor is further configured to:
divide the windshield into a first display area and at least one peripheral display area located in a periphery of the first display area, wherein the first display area is set to include a driving lane of the vehicle, both sides and an upper area of the driving lane with respect to a view seen from the interior of the vehicle toward a straight forward driving direction of the vehicle,
display at least one of driving energy information, speed information, driving lane information, augmented reality (AR) turn by turn (TBT) information, traffic signal information, a distance to a vehicle ahead, warnings, and information related to surrounding vehicles on the first display area, and
display at least one of destination arrival information, media content information, a surrounding real image, an audio video navigation (AVN) menu, speed limit information, and local geographic information on the peripheral display area.

2. The vehicle of claim 1,
wherein the windshield is divided into a driver seat area and a passenger seat area,
wherein the driver seat area includes an internal upper area, an external upper area, an external lower area, and an internal lower area as four quadrant areas with reference to a center portion of the driver seat area, and
wherein the first display area includes at least one portion of the internal upper area, at least one portion of the external upper area, at least one portion of the external lower area, and an entire area of the internal lower area.

3. The vehicle of claim 2, wherein the peripheral display area includes at least one of a second display area located in the external lower area of the driving seat area, a third display area located across the external upper area and the internal upper area of the driver seat area, and a fourth display area located in the passenger seat area.

4. The vehicle of claim 3, wherein the display device is further configured to:
display at least one of a plurality of pieces of navigation TBT information, the speed limit information, and local geographic information on the second display area,
display at least one of the AVN menu, the media content information, the destination arrival information, and the surrounding real image on the third display area, and
display at least one of music lyrics and a media content list on the fourth display area.

5. The vehicle of claim 4,
wherein the media content information includes playback information of a media content, and
wherein the display device displays an AR driving lane line overlapping a line of the driving lane of the first display area in a waveform corresponding to music streaming of the media content according to playback of the media content.

6. The vehicle of claim 5, wherein the display device is further configured to, in response to the media content information displayed on the third display area being dragged to the first display area by a user input, display the AR driving lane line in the waveform corresponding to the music streaming.

7. The vehicle of claim 6, wherein the display device is further configured to, in response to the media content information displayed on the third display area or the AR driving lane displayed in the waveform corresponding to the music streaming being dragged to the fourth display area by a user input, display detailed information of the media content on the fourth display area.

8. The vehicle of claim 4, wherein the display device is further configured to, in response to one of a settings menu of the AVN menu displayed on the third display area being selected and dragged to the fourth display area, display a detailed settings menu of the settings menu on the fourth display area.

9. The vehicle of claim 4,
wherein the surrounding real image includes a rear-view camera image, and
wherein the display device is further configured to, in response to a user input or a change of a driving direction of the vehicle to reverse, expand the rear-view camera image to the first display area, or display a side-view camera image with the expanded rear-view camera image.

10. The vehicle of claim 4, wherein the display device is further configured to, display a plurality of map theme menus on the third display area, and in response to selecting at least one of the plurality of map theme menus, display an AR content corresponding to the at least one of the selected plurality of map theme menus on the first display area.

11. A method of displaying information by a display device on a windshield of a vehicle, the windshield configured to allow for a front view of the vehicle to be seen from an interior of the vehicle, and the display device configured to display preset information on the windshield overlapping the front view, the method comprising:
dividing, by the display device including a processor, the windshield into a first display area and at least one peripheral display area located in a periphery of the first display area, wherein the first display area is set to include a driving lane of the vehicle, both sides and an upper area of the driving lane with respect to a view seen from the interior of the vehicle toward a straight forward driving direction of the vehicle;
displaying, by the display device, at least one of driving energy information, speed information, driving lane information, augmented reality (AR) turn by turn (TBT) information, traffic signal information, a distance to a vehicle ahead, warnings, and information related to surrounding vehicles on the first display area; and
displaying, by the display device, at least one of destination arrival information, media content information, a surrounding real image, an audio video navigation (AVN) menu, speed limit information, and local geographic information on the peripheral display area.

12. The method of claim 11,
wherein the windshield is divided into a driver seat area and a passenger seat area,
wherein the driver seat area includes an internal upper area, an external upper area, an external lower area, and an internal lower area as four quadrant areas with reference to a center portion of the driver seat area, and
wherein the first display area includes at least one portion of the internal upper area, at least one portion of the external upper area, at least one portion of the external lower area, and an entire area of the internal lower area.

13. The method of claim 12, wherein the peripheral display area includes at least one of a second display area in the external lower area of the driver seat area, a third display area located across the external upper area and the internal upper area of the driver seat area, and a fourth display area located in the passenger seat area.

14. The method of claim 13, further including:
displaying, by the display device, at least one of a plurality of pieces of navigation TBT information, the speed limit information, and the local geographic information on the second display area;
displaying, by the display device, at least one of the AVN menu, the media content information, the destination arrival information, and the surrounding real image on the third display area; and
displaying, by the display device, at least one of music lyrics, and a media content list on the fourth display area.

15. The method of claim 14,
wherein the media content information includes playback information of a media content, and
wherein the method further includes displaying, by the display device, an AR driving lane line overlapping a line of the driving lane displayed on the first display area in a waveform corresponding to music streaming of the media content according to playback of the media content.

16. The method of claim 15, further including:
in response to the media content information displayed on the third display area being dragged to the first display area by a user input, displaying, by the display device, the AR driving lane in the waveform corresponding to the music streaming.

17. The method of claim 16, further including:
in response to the media content information displayed on the third display area or the AR driving lane displayed in the waveform corresponding to the music streaming being dragged to the fourth display area by a user input, displaying, by the display device, detailed information of the media content on the fourth display area.

18. The method of claim 14, further including:
in response to a settings menu of the AVN menu displayed on the third display area being selected and dragged to the fourth display area, displaying, by the display device, a detailed settings menu of the settings menu on the fourth display area.

19. The method of claim 14,
wherein the surrounding real image includes a rear-view camera image, and
wherein the method further includes, in response to a user input or a change of a driving direction of the vehicle to reverse, expanding, by the display device, the rear-view camera image to the first display area, or displaying a side-view camera image with the expanded rear-view camera image.

20. The method of claim 14, further including:
displaying, by the display device, a plurality of map theme menus on the third display area, and
in response to selecting at least one of the plurality of map theme menus, displaying, by the display device, an AR content corresponding to the at least one of the selected plurality of map theme menus on the first display area.
